(19) United States
(12) Patent Application Publication
(10) Pub. No.: US 2022/0061571 A1
(43) Pub. Date: Mar. 3, 2022

(54) MAILEYBOX SYSTEM AND METHOD

(71) Applicant: Nikola Milenkovic, Clarendon Hills, IL (US)

(72) Inventor: Nikola Milenkovic, Clarendon Hills, IL (US)

(21) Appl. No.: 17/003,972

(22) Filed: Aug. 26, 2020

(51) Int. Cl. A47G 29/12; A47G 29/124

(52) U.S. Cl. CPC A47G 29/1214; A47G 2029/1229; A47G 29/1245

(57) ABSTRACT

A system and method providing a smart, Internet-connected mailbox is disclosed. The system having a smart mailbox device, a web server, and a mobile device configured to communicatively interconnect over the Internet. The smart mailbox device includes a mailbox enclosure having a lockable mail and package lockbox electrically coupled to a mailbox processor device, a keypad device electrically coupled to the mailbox processor device, a video camera electrically coupled to the mailbox processor device, a display device electrically coupled to the mailbox processor device, a wireless data network transceiver for configured to communicatively interconnect the mailbox device to the Internet, a mailbox processor device for controlling the smart mailbox device, The mailbox processor device has: a memory having instructions stored thereon and a processor configured to execute the instructions on the memory to cause the mailbox processor device to authenticate deliveries and notify users.

### TECHNICAL FIELD

This application relates in general to a system and method for providing delivered package security, and more specifically, to a system and method for a smart, Internet-connected mailbox.

### BACKGROUND

In 2019, the United States Postal Service delivered 6.2 billion packages. Federal Express and United Parcel Service delivered another 11 billion packages. Some industry experts estimate that up to 11% of those packages are misdelivered. That's nearly 2 billion misdelivered packages. Most of these mis-deliveries occur when a driver arrives at an address that doesn't match the address on a package. They either leave the package anyway or return it to the truck for troubleshooting. Additionally, packages are being stolen off recipient's doorsteps as there is little or no oversight over the items once delivered.

Therefore, a need exists for a smart, Internet-connected mailbox. The MaileyBox will provide security for the mail and packages when they are delivered, will provide notification of the deliveries to the owner, and provide a mechanism for the owner to view a live video feed of the MaileyBox. The present invention attempts to address the deficiencies current solutions and needs of recipients of mail and packages according to the principles and example embodiments disclosed herein.

### SUMMARY

In accordance with the present invention, the above and other problems are solved by providing a system and method for a smart, Internet-connected mailbox according to the principles and example embodiments disclosed herein.

In one embodiment, the present invention is a system providing a smart, Internet-connected mailbox. The system having a smart mailbox device, a web server, and a mobile device configured to communicatively interconnect over the Internet. The smart mailbox device includes a mailbox enclosure having a lockable mail and package lockbox electrically coupled to a mailbox processor device, a keypad device electrically coupled to the mailbox processor device, a video camera electrically coupled to the mailbox processor device, a display device electrically coupled to the mailbox processor device, a wireless data network transceiver for configured to communicatively interconnect the mailbox device to the Internet, a mailbox processor device for controlling the smart mailbox device, The mailbox processor device has: a memory having instructions stored thereon and a processor configured to execute the instructions on the memory to cause the mailbox processor device to authenticate deliveries and notify users.

In another aspect of the present disclosure, the processor device is further configured to execute additional instructions on the memory to cause the mailbox processor device to prompt the individual on the display device to reenter an access code using the keypad device when authenticating of the access code fails by the mailbox processor device, and disable access to the lockable mail and package lockbox until reset by a command from the mobile device and send a lockout message to the mobile device when the when authenticating of the access code fails three times.

In another aspect of the present disclosure, the processor device is further configured to execute additional instructions on the memory to cause the mailbox processor device to receive a command to transmit a video stream from the video camera displaying current conditions about the mailbox enclosure, activate the video camera to generate a current video stream, and transmit the current video stream to the mobile device over the Internet

In another aspect of the present disclosure, the processor device is further configured to execute additional instructions on the memory to cause the mailbox processor device to activate the video camera to generate a current video stream when the individual is detected, and store the current video stream into local data storage until the individual is no longer visible for a predetermined amount of time.

In another aspect of the present disclosure, the processor device is further configured to execute additional instructions on the memory to cause the mailbox processor device to retrieve a previous stored video stream from the local data storage in response to a command received from the mobile device, and transmit the previous stored video stream to the mobile device for viewing.

In another aspect of the present disclosure, the wireless data network transceiver communicates over the Internet by sending and receiving wireless data with a wireless network base station within a building associated with the smart mailbox device.

In another aspect of the present disclosure, the wireless data network transceiver communicates over the Internet by sending and receiving wireless data over a cellular data network.

In another aspect of the present disclosure, the authenticated access code is uniquely associated with each mail and package delivery individuals.

In another aspect of the present disclosure, the item arrival message comprises an image of the individual leaving the item and an image of the item.

In another aspect of the present disclosure, the smart mailbox device further comprises the video camera electrically coupled to the mailbox processor device on a front side of the smart mailbox device, and a second video camera electrically coupled to the mailbox processor device on a front side of the smart mailbox device to provide images of the building associated with the smart mailbox device.

In another embodiment, the present invention is a method providing a smart, Internet-connected mailbox. The method detects an individual about the smart mailbox device in images captured by the video camera, prompts the individual on the display device to enter an access code using the keypad device, authenticates the individual using the access code, when the access code is authenticated by the mailbox processor device, unlocks the lockable mail and package lockbox, accepts an item from the individual into the lockable mail and package lockbox, relocks the lockable mail and package lockbox by the mailbox processor device, transmitting an item arrival message to the mobile device via the web server over the Internet.

In another aspect of the present disclosure, the method further when authenticating of the access code fails by the mailbox processor device, prompts the individual on the display device to reenter an access code using the keypad device, and when the when authenticating of the access code fails three times, disables access to the lockable mail and package lockbox until reset by a command from the mobile device and sending a lockout message to the mobile device.

In another aspect of the present disclosure, the method further receives a command to transmit a video stream from the video camera displaying current conditions about the mailbox enclosure, activates the video camera to generate a current video stream, and transmitting the current video stream to the mobile device over the Internet.

In another aspect of the present disclosure, the method further activates the video camera to generate a current video stream when the individual is detected, and stores the current video stream into local data storage until the individual is no longer visible for a predetermined amount of time.

In another aspect of the present disclosure, the method further retrieves a previous stored video stream from the local data storage in response to a command received from the mobile device, and transmit the previous stored video stream to the mobile device for viewing.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiments disclosed may be readily utilized as a basis for modifying or designing other structures for carrying out the same purposes of the present invention. It also should be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of a system that provides a smart, Internet-connected mailbox according to the present invention.

FIG. 2a is a block diagram illustrating an exemplary hardware architecture of a computing device.

FIG. 2b is a block diagram illustrating an exemplary logical architecture for a client device.

FIG. 2c is a block diagram showing an exemplary architectural arrangement of clients, servers, and external services.

FIG. 2d is another block diagram illustrating an exemplary hardware architecture of a computing device.

FIGS. 3a-c illustrate an example embodiment of a system for a smart, Internet-connected mailbox according to the present invention.

FIGS. 4a-d illustrate a computing system of software components for a smart, Internet-connected mailbox according to the present invention.

FIG. 5a-c illustrates a flowchart corresponding to a method performed by software components providing a smart, Internet-connected mailbox according to the present invention.

### DETAILED DESCRIPTION

This application relates in general to a system and method for providing delivered package security, and more specifically, to a system and method for a smart, Internet-connected mailbox according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The term “mobile application” refers to an application executing on a mobile device such as a smartphone, tablet, and/or web browser on any computing device.

The terms “customer,” “recipient,” and “user” refer to an entity, e.g. a human, using the MaileyBox mailbox including any software or smart device application(s) associated with the invention. The term user herein refers to one or more users.

The term “connection” refers to connecting any component as defined below by any means, including but not limited to, a wired connection(s) using any type of wire or cable for example, including but not limited to, coaxial cable(s), fiberoptic cable(s), and ethernet cable(s) or a wireless connection(s) using any type of frequency/frequencies or radio wave(s). Some examples are included below in this application.

The term “invention” or “present invention” refers to the invention being applied for via the patent application with the title “MaileyBox System and Method.” Invention may be used interchangeably with MaileyBox.

The terms “communicate”, or “communication” refer to any component(s) connecting with any other component(s) in any combination for the purpose of the connected components to communicate and/or transfer data to and from any components and/or control any settings.

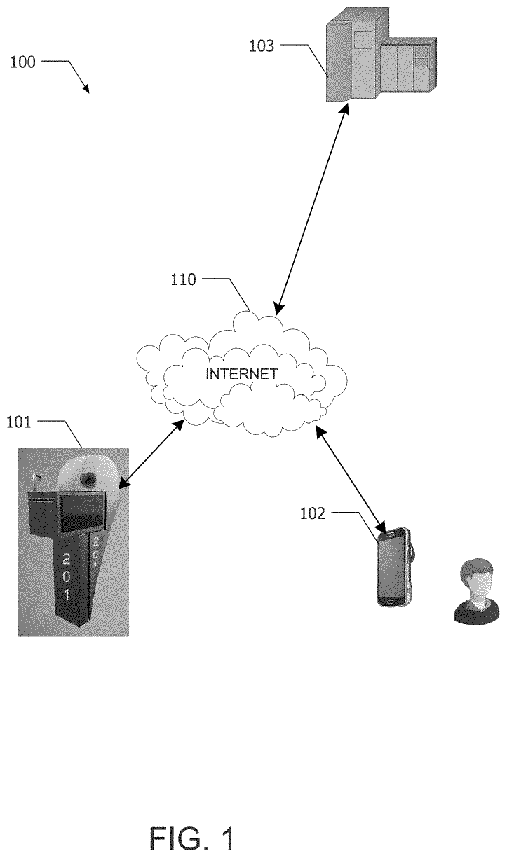

In general, the present disclosure relates to a system and method for providing delivered package security. To better understand the present invention, FIG. 1 illustrates an example embodiment for a system 100 providing a smart, Internet-connected mailbox according to the present invention. This invention is a smart mailbox 101 that will have a display for presenting multimedia data (images and video). The mailbox will have installed security cameras to prevent people from stealing packages and to encompass a view of the customer's front yard and home. Through a mobile application 102 customers can have 24/7 access to the surveillance cameras. The MaileyBox 101 will have a smart indicator that will detect whenever a postal carrier adds new mail in the MaileyBox101. The customer would instantly receive a notification through an app. MaileyBox 101 also will have an automated voice component that could greet or say random messages to anyone who approaches the MaileyBox 101. The owner can control and edit the greeting system. The MaileyBox mobile application 102 also permits customers to display appropriate videos for upcoming holidays or anything else they choose. Customers also can display selected landscape, animal, and personal photos via the video display using the mobile application 102. In the back of the MaileyBox 101 there is a locker specially designed for Amazon and FedEx packages with a security code that a customer can add to his/her profile with those carriers. This would help prevent the common problem of package theft.

A web server 103 provides one or more web applications for adding new devices, media, content, and playlists. The mobile application 102 also notifies users when new mail has arrived. The web server 103 provides a Universal API for communication of all client applications with database in the web server 103. The web server 103 provides a Display application that will collect all data and present on the screen online.

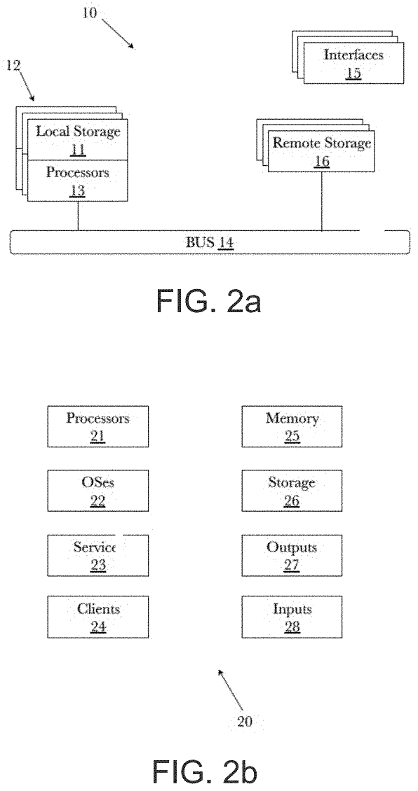

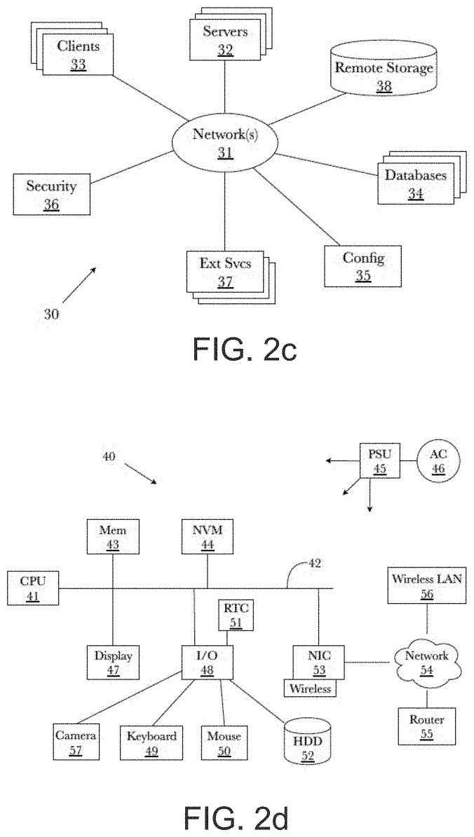

The MaileyBox 101 is configured to detect the insertion and removal of both large and small amount of mail from its secure storage within the device 101. The MaileyBox 101 includes a programmable processing system, and disclosed in FIG. 2-4 below, that obtains images from its camera devices and is capable of telling the difference between a rock and a mail that is contained within a captured image. The system 101 is also capable of recognizing a human in these captures images and automatically plays a sound to communicate with the individual. These sounds are uploaded from a web server 103 and are stored in local memory of the MaileyBox 101.

The invention may use any type of network such as a single network, multiple networks of a same type, or multiple networks of different types which may include one or more of a direct connection between devices, including but not limited to a local area network (LAN), a wide area network (WAN) (for example, the Internet), a metropolitan area network (MAN), a wireless network (for example, a general packet radio service (GPRS) network), a long term evolution (LTE) network, a telephone network (for example, a Public Switched Telephone Network or a cellular network), a subset of the Internet, an ad hoc network, a fiber optic network (for example, a fiber optic service (often known as FiOS) network), or any combination of the above networks.

Smart devices mentioned herein the present application may also use one or more sensors to receive or send signals; wireless signals such as Bluetooth™, wireless fidelity, infrared, Wi-Fi, or LTE. Any smart device mentioned in this application may be connected to any other component or smart device via wired communications (e.g., conductive wire, coaxial cable, fiber optic cable, ethernet cable, twisted pair cable, transmission line, waveguide, etc.), or a combination of wired and wireless communications. The invention's method and/or system may use a single server device or a collection of multiple server devices and/or computer systems.

The systems and methods described above, may be implemented in many different forms of applications, software, firmware, and hardware. The actual software or smart device application codes or specialized control software, hardware or smart device application(s) used to implement the invention's systems and methods is not limiting of the implementation. Thus, the operation and behavior of the systems and methods were described without reference to the specific software or firmware code. Software, smart device application(s), firmware, and control hardware can be designed to implement the systems and methods based on the description herein.

While all of the above functions are described to be provided to users via a mobile application on a smartphone, one of ordinary skill will recognize that any computing device including tablets, laptops, and general purpose computing devices may be used as well. In at least one embodiment, all of the services described herein are provided using web pages being accessed from the web server 201 using a web browser such as Safari™, Firefox™, Chrome™ DuckDuckGo™, and the like. All of the screen examples described herein show user interface elements that provide the functionality of the present invention. The arrangement, organization, presentation, and use of particular user input/output (I/O) elements including hyperlinks, buttons, text fields, scrolling lists, and similar I/O elements are shown herein for example embodiments only to more easily convey the features of the present invention. The scope of the present invention should not be interpreted as being limited by any of these elements unless expressly recited within the attached claims.

For the purposes of the example embodiment of FIG. 1, various functions are shown to be performed on different programmable computing devices that communicate with each other over the Internet 105. These computing devices may include smartphones 101a, laptop computers 101b, tablets (not shown), and similar devices so long as the disclosed functionality of the mobile application described herein is supported by the particular computing device. One of ordinary skill will recognize that this functionality is grouped as shown in the embodiment for clarity of description. Two or more of the processing functions may be combined onto a single processing machine. Additionally, it may be possible to move a subset of processing from one of the processing systems shown here and retain the functionality of the present invention. The attached claims recite any required combination of functionality onto a single machine, if required, and all example embodiments are for descriptive purposes.

For all of the above devices that are in communication with each other, some or all of them need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects, and in order to more fully illustrate one or more aspects. Similarly, although process steps, method steps, algorithms or the like may be described in a sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps generally are described once per aspect, but this does not mean they must occur once, or that they may only occur once each time a process, method or algorithm is carried out or executed. Some steps may be omitted in some aspect or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example, an end-user computer system, a client computer, a network server or other server system, a mobile computing device (e.g., tablet computing device, mobile phone, smartphone, laptop or other appropriate computing device), a consumer electronic device, a music player or any other suitable electronic device, router, switch or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines or other appropriate virtual environments).

Referring now to FIG. 2a, there is a block diagram depicting an exemplary computing device 10 suitable for implementing at least a portion of the features or functionalities disclosed herein. A computing device 10 may be, for example, any one of the computing machines listed in the previous paragraph, or indeed any other electronic device capable of executing software- or hardware-based instructions according to one or more programs stored in memory. A computing device 10 may be configured to communicate with a plurality of other computing devices, such as clients or servers, over communications networks such as a wide area network, a metropolitan area network, a local area network, a wireless network, the Internet or any other network, using known protocols for such communication, whether wireless or wired.

In one aspect, the computing device 10 includes one or more central processing units (CPU) 12, one or more interfaces 15, and one or more buses 14 (such as a peripheral component interconnect (PCI) bus). When acting under the control of appropriate software or firmware, the CPU 12 may be responsible for implementing specific functions associated with the functions of a specifically configured computing device or machine. For example, in at least one aspect, a computing device 10 may be configured or designed to function as a server system utilizing a CPU 12, local memory 11 and/or remote memory 16, and interface(s) 15. In at least one aspect, a CPU 12 may be caused to perform one or more of the different types of functions and/or operations under the control of software modules or components, which for example, may include an operating system and any appropriate applications software, drivers, and the like.

A CPU 12 may include one or more processors 13 such as for example, a processor from one of the Intel, ARM, Qualcomm, and AMD families of microprocessors. In some aspect, processors 13 may include specially designed hardware such as application-specific integrated circuits (ASICs), electrically erasable programmable read-only memories (EEPROMs), field-programmable gate arrays (FPGAs), and so forth, for controlling operations of a computing device 10. In a particular aspect, a local memory 11 (such as non-volatile random access memory (RAM) and/or read-only memory (ROM), including for example, one or more levels of cached memory) may also form part of a CPU 12. However, there are many different ways in which memory may be coupled to a system 10. Memory 11 may be used for a variety of purposes such as, for example, caching and/or storing data, programming instructions, and the like. It should be further appreciated that a CPU 12 may be one of a variety of system-on-a-chip-(SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may, for example, support other peripherals used with a computing device 10. Among the interfaces that may be provided are ethernet interfaces, frame relay interfaces, cable interfaces, DSL interfaces, token ring interfaces, graphics interfaces, and the like. In addition, various types of interfaces may be provided such as, for example, universal serial bus (USB), serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast ethernet interfaces, gigabit ethernet interfaces, serial ATA (SATA) or external SATA (ESATA) interfaces, high-definition multimedia interfaces (HDMI), digital visual interfaces (DVI), analog or digital audio interfaces, asynchronous transfer mode (ATM) interfaces, high-speed serial interfaces (HSSI), point of sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 2a illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and a server system (such as a server system described in more detail below).

Regardless of network device configuration, the system of an aspect may employ one or more memories or memory modules (for example, remote memory block 16 and local memory 11) configured to store data, program instructions for the general-purpose network operations or other information relating to the functionality of the aspects described herein (or any combinations of the above). Program instructions may control execution of or comprise an operating system and/or one or more applications, for example. Memory 16 or memories 11, 16 also may be configured to store data structures, configuration data, encryption data, historical system operations information or any other specific or generic non-program information described herein.

Because such information and program instructions may be employed to implement one or more systems or methods described herein, at least some network device aspects may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device) or they may be removable such as swappable flash memory modules (such as “thumb drives” or other removable media designed for rapidly exchanging physical storage devices), “hot-swappable” hard disk drives or solid state drives, removable optical storage disks, or other such removable media, and that such integral and removable storage media may be utilized interchangeably. Examples of program instructions include both object code, such as may be produced by a compiler, machine code, such as may be produced by an assembler or a linker, byte code, such as may be generated by for example by a JAVA™ compiler and may be executed using a JAVA™ virtual machine or equivalent, or files containing higher level code that may be executed by the computer using an interpreter (for example, scripts written in Python™, Perl™, Ruby™, Groovy™, or any other scripting language).

In some aspects, systems may be implemented on a standalone computing system. Referring now to FIG. 2b, there is a block diagram depicting a typical exemplary architecture of one or more aspects or components thereof on a standalone computing system. A computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the LINUX™ operating system, ANDROID™ operating system, or the like. In many cases, one or more shared services 23 may be operable in system 20, and may be useful for providing common services to client applications 24. Services 23 may, for example, be WINDOWS™ services, user-space common services in a LINUX™ environment or any other type of common service architecture used with an operating system 21. Input devices 28 may be of any type suitable for receiving user input including, for example, a keyboard, touchscreen, microphone (for example, for voice input), mouse, touchpad, trackball or any combination thereof. Output devices 27 may be of any type suitable for providing output to one or more users, whether remote or local to system 20, and may include, for example, one or more screens for visual output, speakers, printers or any combination thereof. Memory 25 may be RAM having any structure and architecture known in the art for use by processors 21, for example to run software. Storage devices 26 may be any magnetic, optical, mechanical, memristor or electrical storage device for storage of data in digital form (such as those described above, referring to FIG. 2a). Examples of storage devices 26 include flash memory, magnetic hard drive, CD-ROM, and the like.

In some aspects, systems may be implemented on a distributed computing network, such as one having any number of clients and/or servers. Referring now to FIG. 2c, there is a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. B. In addition, any number of servers 32 may be provided for handling requests received from one or more clients 33. Clients 33 and servers 32 may communicate with one another via one or more electronic networks 31, which may be in various aspects any Internet, wide area network, mobile telephony network (such as CDMA or GSM cellular networks), wireless network (such as WiFi, WiMAX, LTE, and so forth) or local area network (or indeed any network topology known in the art; the aspect does not prefer any one network topology over another). Networks 31 may be implemented using any known network protocols, including, for example, wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored on a server system 32 in the Cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and use a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web system. It should be understood by one having ordinary skill in the art that any configuration or security subsystems known in the art now or in the future may be used in conjunction with aspects without limitation, unless a specific security 36 or configuration system 35 or approach is required by the description of any specific aspect.

FIG. 2d shows an exemplary overview of a computer system 40 as may be used in any of the various locations throughout the system. It is exemplary of any computer that may execute code to process data. Various modifications and changes may be made to a computer system 40 without departing from the broader scope of the system and method disclosed herein. A CPU 41 is connected to bus 42, to which bus is also connected to memory 43, nonvolatile memory 44, display 47, I/O unit 48, and network interface card (NIC) 53. An I/O unit 48 may, typically, be connected to peripherals such as a keyboard 49, pointing device 50, hard disk 52, real-time clock 51, camera 57, and other peripheral devices. A NIC 53 connects to a network 54, which may be the Internet or a local network, which local network may or may not have connections to the Internet. The system may be connected to other computing devices through the network via a router 55, wireless local area network 56 or any other network connection. Also shown as part of a system 40 is a power supply unit 45 connected, in this example, to a main alternating current (AC) supply 46. Not shown are batteries that could be present and many other devices and modifications that are well known, but are not applicable to, the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles or other integrated hardware devices).

In various aspects, functionality for implementing systems or methods of various aspects may be distributed among any number of client and/or server components. For example, various software modules may be implemented for performing various functions in connection with the system of any particular aspect, and such modules may be implemented to run on server and/or client components.

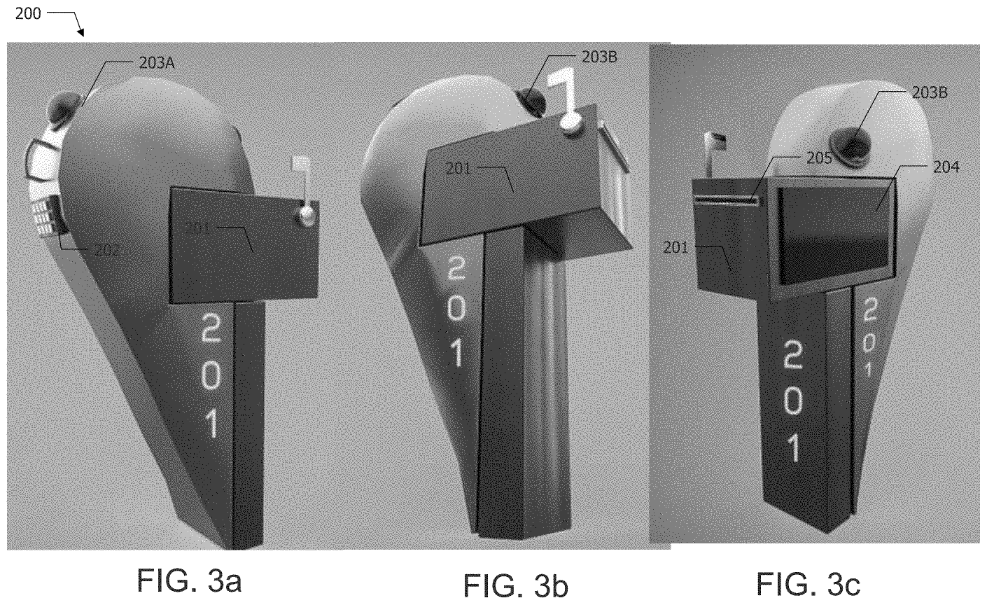

FIGS. 3a-c illustrate another example embodiment of a system for providing a smart, Internet-connected mailbox 200. FIG. 3a shows an embodiment of the MaileyBox 200 from a rear profile view. The MaileyBox 200 has a video camera 203a and a keypad device 202a on the rear side of the mailbox 200. The mailbox enclosure 201 is shown surrounded by the enclosure of the mailbox 101 electronics.

FIG. 3b shows an embodiment of the MaileyBox 200 from a side profile view. In this view a front video camera 203B is shown directed to the front side of the MaileyBox 200. The mailbox enclosure 210 is with its front side directed outward.

FIG. 3c shows an embodiment of the MaileyBox 200 from a front profile view. From the front view, the mailbox enclosure 201 is seen along with a mail slot 205 along the front surface of the mailbox enclosure 201. The front-pointing video camera 203B is shown above the mailbox enclosure 210.

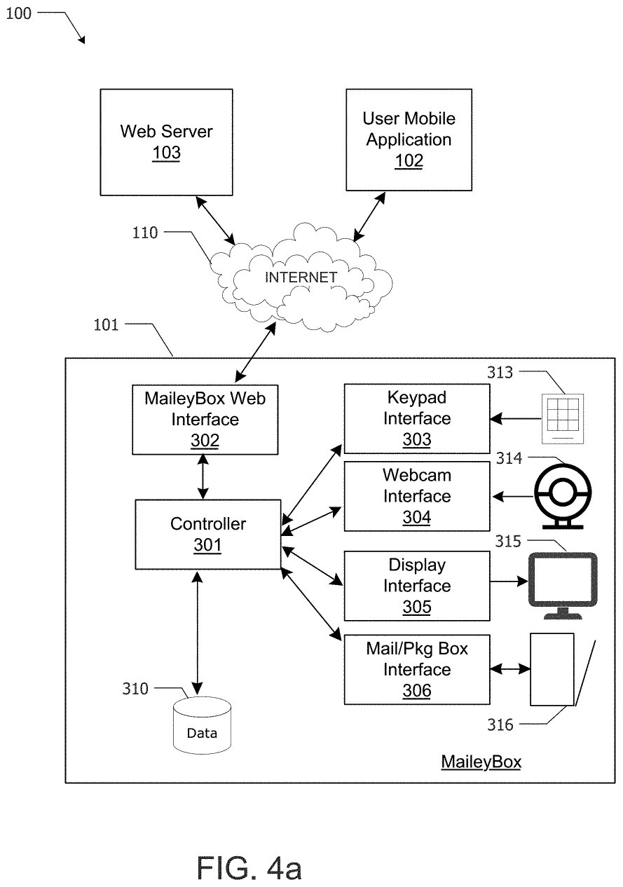

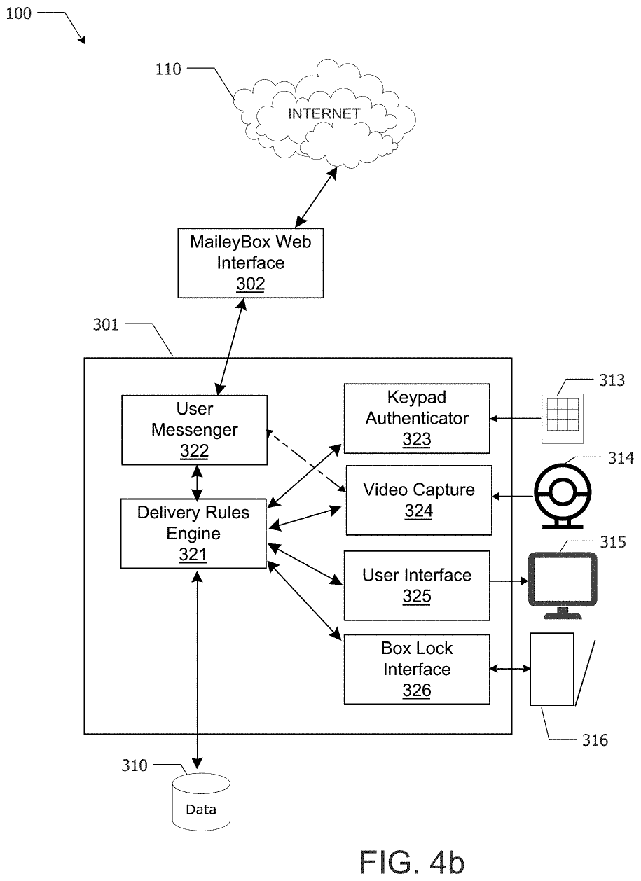

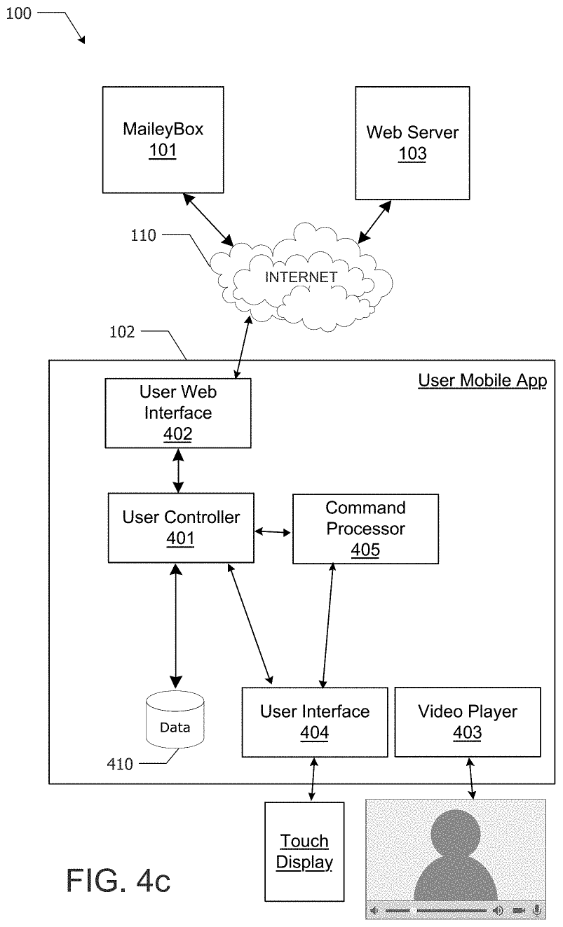

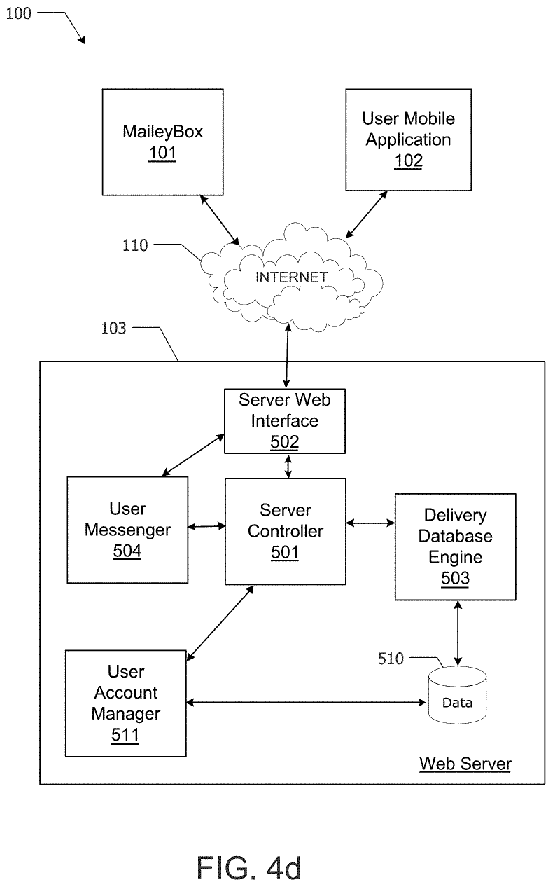

FIGS. 4a-d illustrate a computing system of software components providing a system and method for a smart, Internet-connected mailbox, including a mailbox processor, a mobile application, and a web server. FIG. 4a shows software components within a MaileyBox 101. The MaileyBox 101 comprises a controller 301, a MaileyBox web interface 302, a keypad interface 303 coupled to a keypad input device 310, a webcam interface 304 coupled to a video camera 314, a display interface 305 coupled to a mailbox display 204, and a mail/package interface 306 coupled to a locking mailbox enclosure 316. The MaileyBox 101 has an internal datastore 310 for maintaining all of the data used and generated by the components in the MaileyBox 101.

The MaileyBox web interface 302 permits the mailbox 101 to communicate with remote user mobile applications 102 and the web server 103. The web interface performs all of the data formatting, computer to computer communications, encryption processing, and similar operations needed by the web server to communicate with users. In a preferred embodiment, the Internet speed is important for uploading the data and refreshing the content screen already added, at least should be uploading 20 Mbits/sec downloading 10 Mbit/sec. The MaileyBox device 101 has to be always connected on wireless network whenever possible as well as well protected, because data always is updated with communication to the web server 103. The web interface 302 may communicate over the Internet 110 via a Wifi connection to the adjacent home associated with the particular MaileyBox 101. The web interface 302 may also use a cellular network connection, such and 4G LTE or 5g data to reach the Internet 110.

The keypad interface 303 coupled to a keypad input device 310 connects the input keypad device to the MaileyBox to permit users and delivery personnel to interact with the MaileyBox. Typically, individuals enter access codes into the keypad device 313 to enable the MaileyBox 101 to perform an operation such as unlocking the mailbox lockbox 316. The keypad interface 303 receives the input from the keypad device 313 and converts the input into text data to be used within the MaileyBox 101 processing components.

The webcam interface 304 coupled to the video camera 314 provides a video connection from the video camera 314 for input into a video capture component 324 for further processing. The webcam interface 304 sends commands to the video camera 314 such as when to activate and begin to generate a video stream. The webcam interface 304 also may analyze the video data stream and command the video camera 314 to adjust its aperture and signal gain to provide an optimal image for viewing within the video data stream.

The display interface 305 coupled to a mailbox display 204 generates the images shown to a user on the mailbox display device 204 from streaming video data as well as computer-generated text and graphical data. The display interface 305 matches the data to be displayed to the available image area and pixels and formats the output display data that is sent to the mailbox display 204.

The mail/package interface 306 is coupled to a locking mailbox enclosure 316. The mail/package interface 306 controls when the locking mailbox enclosure 316 is unlocked to be opened to permit a person to place a package within the lockbox enclosure 316 and to be opened to permit the user to retrieve a delivered package. The mail/package interface 306 interacts with the keypad authenticator 323 and the rules engine 321 to determine whether or not a request to unlock the lockbox enclosure 316 is to be granted. The mail/package interface 306 generates control signals to the lockbox enclosure 316 to engage and disengage the locking device.

FIG. 4b shows software components within the controller 301 of the MaileyBox 101. The controller 301 comprises a delivery rules engine 321, a user messenger 322, a keypad authenticator 323 coupled to the keypad device 313 via the keypad interface 303 (not shown), a video capture 324 coupled to the video camera 314 via the webcam interface 304 (not shown), a user interface 325 coupled to the display device 315 via the display interface 305 (not shown), and a lockbox interface 326 coupled to the locking mailbox enclosure 316 via the mail/package interface 306 (not shown).

The delivery rules engine 321 The rules engine I assume will match the functions of the controller and define what the MaileyBox does in a given circumstance. Once I have all of the functions and their possible parameters, I can flesh this out further.

The user messenger 322 generates and transmits messages to the user's mobile application 102 in response to events that occur at the MaileyBox 101. The web server 103 also may receive notification of these events from the messenger 322 within the MaileyBox 101 when mail or a package is delivered, as well as when someone attempts to break into the mailbox lockbox 316. The user messenger 322 creates these messages and sends them to the user. Depending upon the priority of the notification, the user messenger 322 may choose the method of communications as well as the message content.

The keypad authenticator 323 coupled to the keypad device 313 via the keypad interface 303 (not shown) receives and processes the input from the keypad device 313 to determine if the action being requested, such as opening the lockbox 316 to accept a package, should be performed. The keypad authenticator 323 maintains access codes for the user, for delivery companies, and support staff and compares the received input with these codes. The keypad authenticator 323 may also prompt the user periodically to change these access codes if the current values have been in use for a long length of time.

The video capture 324 coupled to the video camera 314 via the webcam interface 304 (not shown) receives and processes the raw video output from the video camera 314 and formats it for storage locally, for transmission to the mobile application 102 if to be viewed live, and for transmission to the web server 103 for storage into the database for later retrieval by the user. The video capture 324 performs any video encoding and data compression, if needed, to transmit the video data over the Internet 110. The video capture 324 also may retain the last few captured videos locally for display to the user on the display device 204 of the MaileyBox 101.

The user interface 325 coupled to the display device 315 via the display interface 305 (not shown) provides the MaileyBox 101 the ability to provide visual output data to a user on the mailbox display device 204. This visual output may be text data that permits the user to interact with the MaileyBox 101 to set expected delivery date and times and to set up and change the access codes and other settings for the operation of the MaileyBox 101. The user interface 325 also may retrieve stored video data from local storage 310 and from the web server 103 for display on the mailbox display device 204.

The lockbox interface 326 coupled to the locking mailbox enclosure 316 via the mail/package interface 306 (not shown) controls when the lockbox enclosure 316 may be opened and when it is to remain locked.

FIG. 4c shows the software components within the user mobile application 102. The mobile application comprises a user controller 401, a user web interface 402, a video player 403, a user interface 404, a command processor 405, and a local app datastore 410. The user controller 401 receives data from the web server 103 that has been collected from the user's MaileyBox 101. The user controller 401 also receives and processes user commands from the user to control the MaileyBox 101 and corresponding user account on the web server 103.

In a preferred embodiment the user controller 401 may include a web browser that performs web applications provided by the web server 103. These web application may allow the user to enter data using any web standard based web browser such as Google Chrome™ Mozilla, Opera, and Apple Safari™ browsers. The user controller 401 may receive notifications of new mail being delivered to the user's MaileyBox 101 using notification APIs supported by mobile operating systems such iOS™ and Android™. After new data is sent to the device 102, the data will be stored locally to the next connection for refreshing. New mails added to the MaileyBox will need wireless connection that MB can inform the user on mobile phone that new mail arrived.

The user web interface 402 permits the mobile application 102 to communicate with remote MaileyBox 101 mailboxes, and the web server 103. The user web interface 402 performs all of the data formatting, computer-to-computer communications, encryption processing, and all similar operations needed by the web server to communicate with users. In a preferred embodiment, the Internet speed is important for uploading the data and refreshing the content screen already added, at least should be uploading 20 Mbits/sec downloading 10 Mbit/sec.

The video player 403 provides the mobile application 102 the ability to display a video captured by the MaileyBox 101 to be displayed on the display device of the user's mobile device. These videos may be ones that were captured when a package was delivered or when an event occurred. These videos also may provide a live streaming data feed from the MaileyBox 101 in order for the user to observe the present conditions at the mailbox.

The user interface 404 provides the user of the mobile application 102 the ability to provide input commands to the mobile application as well as receive textual and other visual and auditory data from the mobile application 102. The user interface 404 uses supported input and out (I/O) devices of the mobile devices that are running the mobile application.

The command processor 405 performs the functions necessary to perform commands requested by the user. For example, the user may provide a command to display the current video stream of the MaileyBox 101 after receiving notification of a delivery. The command processor 405 performs this particular function to communicate with the web server 103 and the MaileyBox 101 to activate the video camera 314, to collect and store the video stream, and to route the live video data stream to the mobile application for viewing. In some cases, the command processor 405 may be required to communicate with both the MaileyBox 101 and the web server 103, where in other cases, the command processor 405 may only need the assistance of the two devices. All of the supported functions of the mobile application 102 are contained within the logic and instructions of the command processor 405.

The local app datastore 410 comprises local memory available to the mobile application to store data as part of the application's long-term storage. Past notifications, videos, user messages and the like may be retained by the mobile application 102 for the user to view and act upon at a later date. The datastore 410 may consist of memory storage provided to the mobile application 102 by the underlying mobile device.

FIG. 4d shows the components within the web server 103. The web server 103 comprises a server controller 501, a server web interface 502, a delivery database engine 503 coupled to a web server data store 510, a user messenger 504 and a user account manager 511. The server controller 501 receives the delivery notification message 142 via the server web interface 502 when it arrives from the MaileyBox 101 and the mobile application 102. The server controller 501 provides each user account and maintains an online database of mail and packages delivered to each MaileyBox 101. The server controller also provides each user account a predefined amount of data to store information regarding the mail and packages delivered to the MaileyBox 101. In a preferred embodiment, each user account may be allocated 1 GB of data within the database 510 on the web server 103. Of course, larger amounts of storage may also be provided, at an increase cost, if needed.

The server web interface 502 connects the server 103 to the Internet 110 to send and receive communication from users' mobile applications 102 and MaileyBox 101 smart mailboxes. The web server interface 502 performs all necessary data formatting, data packet creation, data encryption for security, and data transmission and reception when the server 103 communicates with other processing systems disclosed herein. The web server interface 502 is also responsible to ensure reception of any communications to other computing systems and to log any errors or attempts to hack into the web server data store 510.

The delivery database engine 503 is coupled to a web server data store 510 to maintain all of the delivery notifications, surveillance videos, and related data for the user. The delivery database engine 503 processes all database operations for the web server 103. These operations include insertion of delivery notifications, messages, videos, and the like into the database 510, deletion of delivery notifications, messages, videos, and the like from the database 510, searching and retrieving notification and video data from the database 510 in response to user queries from the mobile application 102, and indexing the database 510 to maintain efficient searching when needed.

The user messenger 504 generates and transmits messages to the user mobile application 102 in response to events that occur at the MaileyBox 101 mailbox. The web server 103 receives notification from the mailbox 101 when mail or a package is delivered as well as when someone attempts to break into the mailbox lockbox. The user messenger 504 creates these messages and sends them to the user. Depending upon the priority of the notification, the user messenger 504 may choose the method of communications as well and the message content. For example, an ordinary delivery of mail or a package may only require an email be sent to the user's mobile application 102. In contrast, an attempted break in into the mailbox lockbox 316 may require a more immediate message such as a recorded phone call to a mobile device or an SMS text message that indicates that something out of the ordinary needs the user's immediate attention.

Users of the MaileyBox 101 and its web server 103 typically utilize a user account that is unique for each user. These accounts allow the server to distinguish various users from each other, identify the MaileyBox 101 associated with the user, and permit each user to tailor the notifications to be provided to the mobile application 102 as desired. The user account manager 511 permits the user to create an account, set up any authentication to be used to access the web server 103 as well as the MaileyBox 101, maintain any user settings, and maintain a user profile.

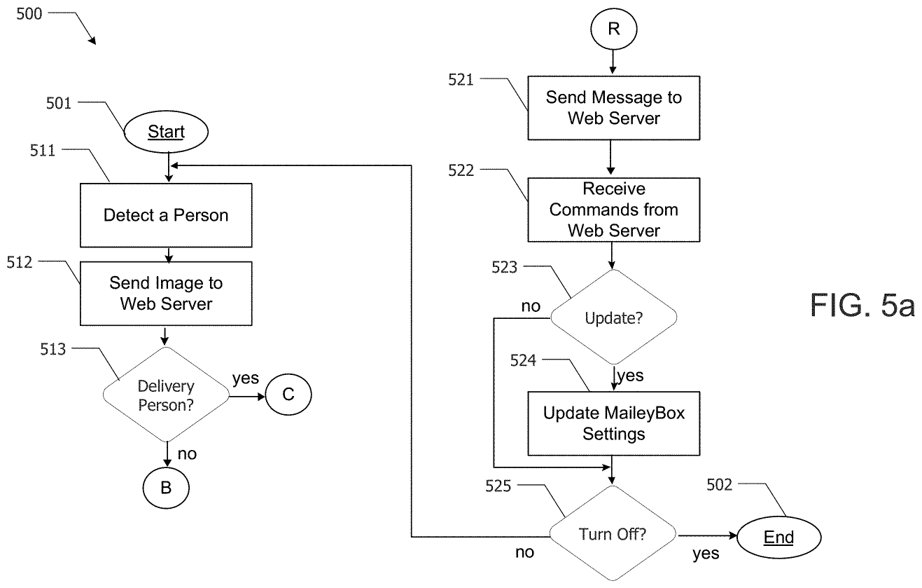

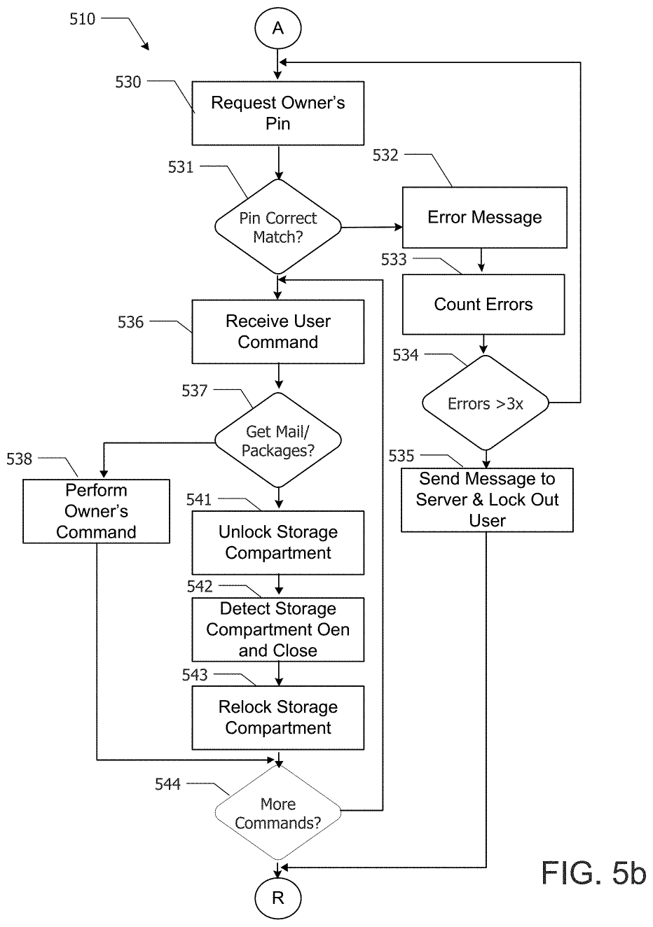

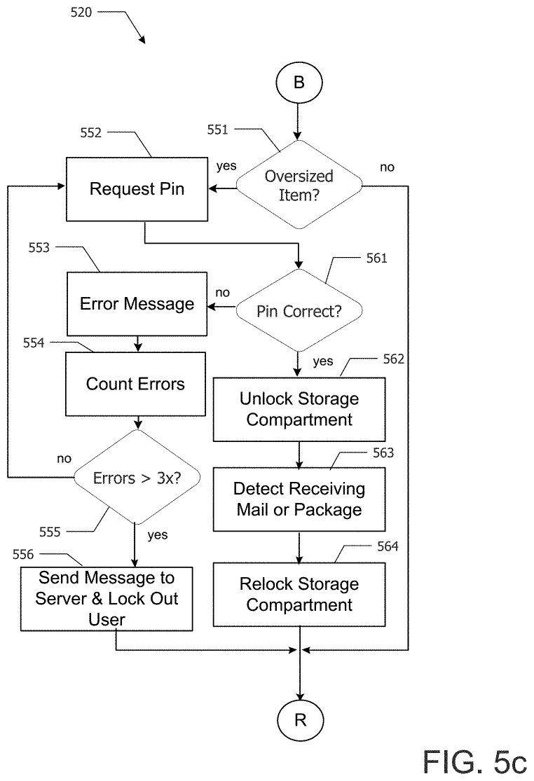

FIGS. 5a-c illustrates a flowchart corresponding to a method performed by software components providing a system and method for a smart, Internet-connected mailbox. In FIG. 5a, the method 500 begins 510 and the MaileyBox 101 detects a person at the device in step 511. The MaileyBox 101 sends a copy of the image to the web server 103 in step 512. Test step 513 determines if the person detected is a delivery person, the process C performs the method 520 shown in FIG. 5c. When test step 513 determines if the person detected is not delivery person, the process B performs the method 510 shown in FIG. 5b.

When the processes B and C end, the method 500 returns R and the MaileyBox 101 sends, in step 521, a message regarding the events associated with the methods 510, 520. Step 522 receives a response from the web server. Test step 523 determines if an update to the MaileyBox 101 settings is required, and if so, step 524 updates the settings; otherwise the method 500 passes directly to test step 525. Test step 525 determines if the MaileyBox 101 is being turned off, and if not, the method 500 returns to step 511 to await the next individual; otherwise the method 500 ends 502.

FIG. 5b illustrates the method 510 that the MaileyBox 101 performs when the owner is detected. The method 510 begins with a request of the owner's pin in step 530 that is received from the keypad device 313. Test step 531 determines if the pin entered is correct, and if not, step 532 generates an error message, step 533 counts the number of errors received in a row, and test step 534 determines whether the number of errors in a row is greater than 3 times. When test step 534 determines that the number of errors is not greater than three times, the method 510 returns to step 530 to permit the owner to re-enter the PIN; otherwise the method 510 sends a message to the web server 103 that multiple erroneous attempts to enter the owner's PIN were received in order for the web server 103 to notify the owner and the MaileyBox operation is locked. The method returns R to the overall method 500 of FIG. 5a.

Returning to test step 531 and the Owner's PIN is correct, step 536 receives a command from the owner. Test step 537 determines whether the command received from the owner is a request to retrieve mail and packages, and if not, the MaileyBox 101 performs the command to update the MaileyBox accordingly in step 538 and test step 544 determines whether the owner is completed the interaction with the MaileyBox 101. When the owner is determined to perform more tasks, the method 510 returns to step 536 to receive the next command; otherwise the method returns R to the main method 500 in FIG. 5a.

Returning to test step 537, when the MaileyBox determines that the owner is retrieving mail and packages, step 541 unlocks the storage compartment of the MaileyBox 101, step 543 detects the opening and closing of the storage compartment indicating that the mail and packages have been retrieved, and step 543 relocks the storage compartment. Once again, test step 544 determines whether the owner has more commands, and if so the method 510 returns to step 536 to receive the next command; otherwise the method returns R to the main method 500 in FIG. 5a.

FIG. 5c illustrates the method 520 that the MaileyBox 101 performs when the delivery person is detected. The method 520 begins with test step 551 determining whether the items to be delivered are oversized or not as regular mail may be directly inserted into the mail slot of the front of the MaileyBox. When test step determines that the items are regular mail, the method 520 simply returns R to the main method 500 in FIG. 5a; otherwise the delivery person must gain access to the storage compartment to receive the items.

Step 552 requests the delivery person to enter an access PIN, Next, test step 561 determines if the pin entered is correct, and if not, step 553 generates an error message, step 554 counts the number of errors received in a row, and test step 555 determines whether the number of errors in a row is greater than 3 times. When test step 555 determines that the number of errors is not greater than three times, the method 520 returns to step 552 to permit the delivery person to re-enter the PIN; otherwise the method 520 sends a message to the web server 103 that multiple erroneous attempts to enter the owner's PIN were received in order for the web server 103 in step 556 to notify the owner and the MaileyBox operation is locked. The method 520 returns R to the overall method 500 of FIG. 5a.

Returning to test step 561 and the MaileyBox 101 determines that the delivery person has entered the correct access, step 562 unlocks the storage compartment of the MaileyBox 101, step 563 detects the opening and closing of the storage compartment indicating that the mail and packages have been received, and step 564 relocks the storage compartment. The method then returns R to the main method 500 in FIG. 5a.

The embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise. Any singular term used in this present patent application is applicable to its plural form even if the singular form of any term is used.

In the present application, all or any part of the invention's software or application(s) or smart device application(s) may be installed on any of the user's or operator's smart device(s), any server(s) or computer system(s) or web application(s) required to allow communication, control (including but not limited to control of parameters, settings such as for example, sign copy brightness, contrast, ambient light sensor settings . . . etc.), transfer of content(s) or data between any combination of the components.

What is claimed is:

1. A system for providing a smart, Internet-connected mailbox, the system having a smart mailbox device, a web server, and a mobile device configured to communicatively interconnect over the Internet, the smart mailbox device comprising:
a mailbox enclosure having a lockable mail and package lockbox electrically coupled to a mailbox processor device;
a keypad device electrically coupled to the mailbox processor device;
a video camera electrically coupled to the mailbox processor device;
a display device electrically coupled to the mailbox processor device;
a wireless data network transceiver for configured to communicatively interconnect the mailbox device to the Internet;
a mailbox processor device for controlling the smart mailbox device, the mailbox processor device comprises:
a memory having instructions stored thereon; and
a processor configured to execute the instructions on the memory to cause the mailbox processor device to:
detect an individual about the smart mailbox device in images captured by the video camera;
prompt the individual on the display device to enter an access code using the keypad device;
authenticate the individual using the access code;
when the access code is authenticated by the mailbox processor device, unlock the lockable mail and package lockbox;
accept an item from the individual into the lockable mail and package lockbox;
relock the lockable mail and package lockbox by the mailbox processor device;
transmit an item arrival message to the mobile device via the web server over the internet.

2. The system according to claim 1, wherein the processor device is further configured to execute additional instructions on the memory to cause the mailbox processor device to:
when authenticating of the access code fails by the mailbox processor device, prompt the individual on the display device to reenter an access code using the keypad device; and
when the when authenticating of the access code fails three times, disable access to the lockable mail and package lockbox until reset by a command from the mobile device and send a lockout message to the mobile device.

3. The system according to claim 1, wherein the processor device is further configured to execute additional instructions on the memory to cause the mailbox processor device to:
receive a command to transmit a video stream from the video camera displaying current conditions about the mailbox enclosure;
activate the video camera to generate a current video stream; and
transmit the current video stream to the mobile device over the Internet.

4. The system according to claim 1, wherein the processor device is further configured to execute additional instructions on the memory to cause the mailbox processor device to:
activate the video camera to generate a current video stream when the individual is detected; and
store the current video stream into local data storage until the individual is no longer visible for a predetermined amount of time.

5. The system according to claim 4, wherein the processor device is further configured to execute additional instructions on the memory to cause the mailbox processor device to:
retrieve a previous stored video stream from the local data storage in response to a command received from the mobile device; and
transmit the previous stored video stream to the mobile device for viewing.

6. The system according to claim 1, wherein the wireless data network transceiver communicates over the Internet by sending and receiving wireless data with a wireless network base station within a building associated with the smart mailbox device.

7. The system according to claim 1, wherein the wireless data network transceiver communicates over the Internet by sending and receiving wireless data over a cellular data network.

8. The system according to claim 1, wherein the authenticated access code is uniquely associated with each mail and package delivery individuals.

9. The system according to claim 1, wherein the item arrival message comprises an image of the individual leaving the item and an image of the item.

10. The system according to claim 1, wherein the smart mailbox device further comprises:
the video camera electrically coupled to the mailbox processor device on a front side of the smart mailbox device; and
a second video camera electrically coupled to the mailbox processor device on a front side of the smart mailbox device to provide images of the building associated with the smart mailbox device.

11. A method for providing a smart, Internet-connected mailbox, the method comprising:
detecting an individual about the smart mailbox device in images captured by the video camera;
prompting the individual on the display device to enter an access code using the keypad device;
authenticating the individual using the access code;
when the access code is authenticated by the mailbox processor device, unlocking the lockable mail and package lockbox;
accepting an item from the individual into the lockable mail and package lockbox;
relocking the lockable mail and package lockbox by the mailbox processor device;
transmitting an item arrival message to the mobile device via the web server over the internet.
detecting an individual about the smart mailbox device in images captured by the video camera;
prompting the individual on the display device to enter an access code using the keypad device;
authenticating the individual using the access code;
when the access code is authenticated by the mailbox processor device, unlocking the lockable mail and package lockbox;
accepting an item from the individual into the lockable mail and package lockbox;
relocking the lockable mail and package lockbox by the mailbox processor device;
transmitting an item arrival message to the mobile device via the web server over the internet.

12. The method according to claim 11, wherein the method further:
when authenticating of the access code fails by the mailbox processor device, prompting the individual on the display device to reenter an access code using the keypad device; and
when the when authenticating of the access code fails three times, disabling access to the lockable mail and package lockbox until reset by a command from the mobile device and sending a lockout message to the mobile device.

13. The method according to claim 12, wherein the method further:
receiving a command to transmit a video stream from the video camera displaying current conditions about the mailbox enclosure;
activating the video camera to generate a current video stream; and
transmitting the current video stream to the mobile device over the Internet.

14. The method according to claim 12, wherein the method further:
activating the video camera to generate a current video stream when the individual is detected; and
storing the current video stream into local data storage until the individual is no longer visible for a predetermined amount of time.

15. The method according to claim 12, wherein the method further:
retrieving a previous stored video stream from the local data storage in response to a command received from the mobile device; and
transmit the previous stored video stream to the mobile device for viewing.
